(19) United States
(12) Patent Application Publication
(10) Pub. No.: US 2023/0359747 A1
(43) Pub. Date: Nov. 9, 2023

(54) CONTAINER-BASED ENCRYPTION OF DATA AT REST FOR VIRTUAL MACHINES IN A CLOUD ENVIRONMENT

(71) Applicant: Avaya Management L.P., Durham, NC (US)

(72) Inventors: Harsimran Jeet Singh, Pune (IN); Kiran Barhate, Pune (IN); Sandeep Goynar, Pune (IN)

(21) Appl. No.: 17/736,003

(22) Filed: May 3, 2022

(51) Int. Cl. G06F 21/60; G06F 21/78; H04L 9/08

(52) U.S. Cl. CPC G06F 21/602; G06F 21/78; H04L 9/0861

(57) ABSTRACT

The technology disclosed herein enables encryption of data at rest for virtual machines using a container orchestration platform. In a particular embodiment, a method includes, in the container orchestration platform receiving a data access request from a virtual machine external to the container orchestration platform. The data access request requests that data be stored in a storage repository. After receiving the data access request, the method includes encrypting the data using a key associated with the virtual machine. After encrypting the data, the method includes storing the data in the storage repository.

### TECHNICAL BACKGROUND

For a cloud computing environment, such as an environment that provides Infrastructure as a Service (Iaas) or Platform as a Service (PaaS), it is desirable to encrypt data at rest (i.e., data stored to a physical storage and not in transit) for Virtual Machines in the environment. Often, depending on the requirements of a customer of the cloud computing environment, concerns may arise surrounding the encryption of the data and who manages keys used to encrypt the data. Commonly, cloud computing providers provide three encryption options to customers, platform managed keys, customer managed keys, or key stores that can be external or internal. All of those options, being provided by the providers themselves, affect the trust factor of customer regarding whether their data is secure from attacks both from outside and within a cloud computing environment.

### SUMMARY

The technology disclosed herein enables encryption of data at rest for virtual machines using a container orchestration platform. In a particular embodiment, a method includes, in the container orchestration platform receiving a data access request from a virtual machine external to the container orchestration platform. The data access request requests that data be stored in a storage repository. After receiving the data access request, the method includes encrypting the data using a key associated with the virtual machine. After encrypting the data, the method includes storing the data in the storage repository.

In some examples, the method includes, in response to determining that a new key should be used for encrypting the data, creating the key. In those examples, creating the key may include using a YAML template for key generation. Also in those examples, the method may include determining that the new key should be used when a previous key has expired. A containerized encryption service may receive the data access request and encrypts the data, and a containerized key service creates the key. The containerized key service may provide the key to the containerized encryption service in response to a request for the key from the containerized encryption service.

In some examples, the method includes, in the container orchestration platform, receiving another data access request from the virtual machine. The other data access request requests the data from the storage repository. The method also includes decrypting the data using the key and, after decrypting the data, providing the data to the virtual machine.

In some examples, the method includes, in the container orchestration platform receiving a second data access request from a second virtual machine. The second data access request requests that second data be stored in the storage repository. In response to the second data access request, the method includes encrypting the data using a second key associated with the second virtual machine and, after encrypting the second data, storing the second data in the storage repository.

In some examples, the method includes identifying the key from a data structure that stores associations between keys and virtual machines.

In some examples, the key is only used for data access requests received from the virtual machine.

In another example, an apparatus is provided having one or more computer readable storage media and a processing system operatively coupled with the one or more computer readable storage media. Program instructions stored on the one or more computer readable storage media that, when read and executed by the processing system, direct the apparatus to, in a container orchestration platform, receive a data access request from a virtual machine external to the container orchestration platform. The data access request requests that data be stored in a storage repository. After receiving the data access request, encrypt the data using a key associated with the virtual machine and, after encrypting the data, store the data in the storage repository.

### BRIEF DESCRIPTION OF THE DRAWINGS

FIG. 1 illustrates an implementation for encrypting data at rest for virtual machines in a cloud environment.

FIG. 2 illustrates an operation to encrypt data at rest for virtual machines in a cloud environment.

FIG. 3 illustrates an operational scenario for encrypting data at rest for virtual machines in a cloud environment.

FIG. 4 illustrates an implementation for encrypting data at rest for virtual machines in a cloud environment.

FIG. 5 illustrates a logical arrangement of the above implementation when encrypting data at rest for virtual machines in a cloud environment.

FIG. 6 illustrates an operational scenario for encrypting data at rest for virtual machines in a cloud environment.

FIG. 7 illustrates an operational scenario for encrypting data at rest for virtual machines in a cloud environment.

FIG. 8 illustrates an operational scenario for encrypting data at rest for virtual machines in a cloud environment.

FIG. 9 illustrates a computing architecture for encrypting data at rest for virtual machines in a cloud environment.

### DETAILED DESCRIPTION

The container orchestration platforms described herein encrypt data from virtual machines outside of the platforms for storage in a data storage repository. The platforms similarly handle the decryption of the data when requested from the storage repository by the virtual machines. Keys used to encrypt and, subsequently, decrypt data are maintained within the container orchestration platform by one or more containers being hosted by the platform. A customer, or other entity, of a cloud computing provider (e.g., purchasing IaaS or PaaS services of the provider) can implement the containers in the provider's cloud computing environment. By implementing the containers themselves, the customer remains in complete control of data encryption, and the keys used in that encryption, for data being stored by virtual machines that the customer is also implementing in the cloud computing environment.

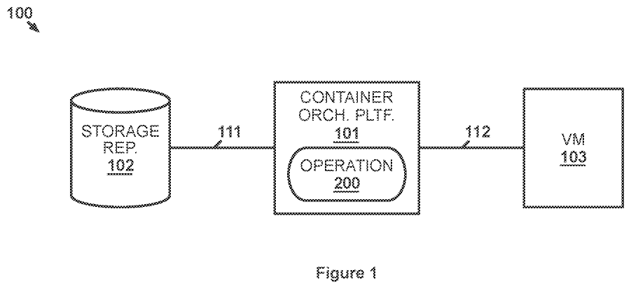

FIG. 1 illustrates implementation 100 for encrypting data at rest for virtual machines in a cloud environment. Implementation 100 includes container orchestration platform, storage repository 102, and virtual machine 103. Although not shown, container orchestration platform 101 and virtual machine 103 execute on one or more physical host computing systems (e.g., servers). Container orchestration platform and storage repository 102 communicate over logical communication link 111. Container orchestration platform and virtual machine 103 communicate over logical communication link 112. Logical communication links 111-112 may be overlay links that carry communications over wired and/or wireless physical communication links, which may be direct links but may include intervening systems, networks, and/or devices, and/or may include software implemented links between components executing on the same physical host computing system. Storage repository 102 includes one or more computer readable storage media to which data is stored. Storage repository 102 may further include processing and communication circuitry to exchange data communications over logical communication link 111.

Container orchestration platform 101 is a software process, such as Kubernetes®, that is executed to automatically manage the execution of applications in containers on host computing systems. A container is hosted by a container engine, which is a virtualization software process that emulates an operating system for an application executing in a container. The container engine allocates resources of the host computing system between containers executing on that system. Virtual machine 103 is hosted by a hypervisor, which is a virtualization software process that emulates computing hardware onto which an operating system within virtual machine 103 can execute. The hypervisor translates that virtualized hardware to the physical hardware of a host computing system and enables the physical hardware to be shared among multiple virtual machines executing thereon. In some examples, storage repository 102 may itself be virtualized on physical storage and/or computing hardware. Operation 200 is performed within container orchestration platform 101 to encrypt data that virtual machine 103 stores in storage repository 102.

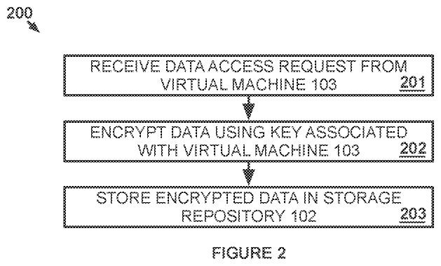

FIG. 2 illustrates operation 200 to encrypt data at rest for virtual machines in a cloud environment. Operation 200 may be performed by one or more containers instantiated by container orchestration platform 101. In operation 200, a data access request is received from virtual machine 103 (201). Virtual machine 103 is external to container orchestration platform 101 by virtue of it being a virtual machine rather than a container that is subject to container orchestration platform 101's control. Virtual machine 103 may be implemented as part of an IaaS or PaaS offering of a cloud computing provider on host computing systems provided by the cloud computing provider. Container orchestration platform 101 may also be implemented on host computing systems provided by the cloud computing provider. The data access request requests that data be stored in storage repository 102. Virtual machine 103, or an operating system or process executing thereon, may be configured to transfer the data access request to a container of container orchestration platform 101 rather than directly to storage repository 102. In some examples, the data may be received as part of, or along with, the data access request (e.g., the data access request may be an instruction to store the data included therewith).

After receiving the data access request, the data is encrypted using a key associated with virtual machine 103 (202). Any data encryption algorithm may be used to encrypt the data from virtual machine 103. Encryption keys are data used as input to a data encryption algorithm and affect the resulting encrypted data. When a particular key is used as input to encrypt the data, the same key must be used as input to decrypt the data. Otherwise, the data encryption algorithm will not output properly decrypted data. Keys, therefore, secure data by only allowing decryption of data when the key used to encrypt the data is provided. By associating the key with virtual machine 103, data access requests from virtual machine 103 will use the key to either encrypt being stored to storage repository 102 or decrypt data being read from storage repository 102. A data structure, such as a table, may be maintained to associate the key with virtual machine 103 along with other key/virtual machine associations. The data structure may also maintain an age of each key in examples where keys expire after a defined period of time. Each key may be associated with only one virtual machine in some examples. In other examples, a key may be associated with more than one virtual machine. For instance, if two or more virtual machines are using the same data in storage repository 102, then the key may be associated with multiple virtual machines. In those examples, the virtual machine storing the data may identify other virtual machines that can use the same key. A virtual machine may be identified based on an Internet Protocol (IP) address of the virtual machine, a Media Access Control (MAC) address of the virtual machine, a unique identifier assigned to the virtual machine by the cloud computing platform, a unique identifier assigned to a process executing on the virtual machine, or some other type of identifier that uniquely identifies the virtual machine relative to other virtual machines. Virtual machine 103 may, therefore, be identified via an identifier indicated by (e.g., received within) the data access request received therefrom.

After encrypting the data, the data is stored in storage repository 102 (203). In this example, the encrypted data is transmitted over logical communication link 111 to storage repository 102. Advantageously, even if virtual machine 103 is compromised by malicious activity, virtual machine 103 does not maintain keys for any data stored in storage repository 102. Likewise, as the same entity (e.g., customer of the cloud computing provider) can control both container orchestration platform 101 and virtual machine 103, the entity can manage their own data security without having to rely on the cloud computing provider.

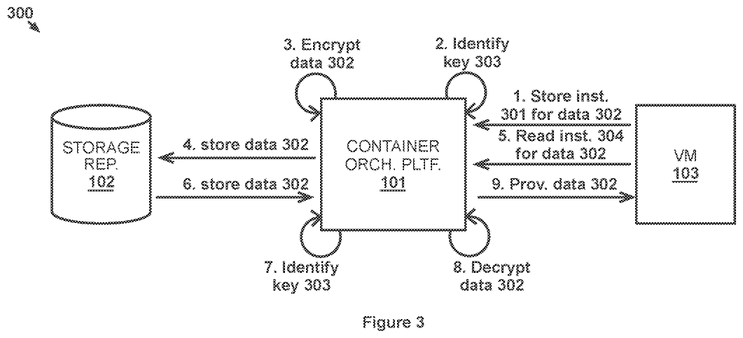

FIG. 3 illustrates operational scenario 300 for encrypting data at rest for virtual machines in a cloud environment. Operational scenario 300 is an example of storing and reading data from storage repository 102. In particular, virtual machine 103 transmits data store instruction 301 (i.e., a data access request) at step 1 to container orchestration platform 101 (i.e., to a container instantiated by container orchestration platform 101). In this example, data 302 is to be stored and is transmitted with data store instruction 301. Upon receiving data store instruction 301, key 303 associated with virtual machine 103 is identified at step 2 in a data structure maintained by container orchestration platform 101. For example, an identifier of virtual machine 103 included with data store instruction 301 may be referenced in the data structure and key 303 may correspond to the identifier in the data structure. Data 302 is encrypted using key 303 at step 3 and then stored to storage repository 102 at step 4. Data 302 may be stored by transmitting a data access request similar to data store instruction 301 when storing the encrypted form of data 302 to storage repository 102, although, storage repository 102 may be instructed using some other mechanism. Container orchestration platform 101 may maintain

At a time after data 302 has been stored in storage repository 102, virtual machine 103 transmits data read instruction 304 at step 5 to container orchestration platform 101. Data read instruction 304 is a data access request that requests data 302 be provided to virtual machine 103. In response to receiving data read instruction 304, data 302 is retrieved at step 6 from storage repository 102. Data read instruction 304 may include an identifier for data 302 that virtual machine 103 provided with data store instruction 301 or was provided to virtual machine 103 as part of container orchestration platform 101 storing data 302. Using that identifier, container orchestration platform 101 knows which data to request from storage repository 102. Data 302, when received from storage repository 102, is encrypted. Key 303 is identified at step 7 (although could occur at any time after data read instruction 304 is received) as being the key associated with virtual machine 103. Accordingly, key 303 is used to decrypt data 302 at step 8. The decrypted version of data 302 is provided to virtual machine 103 at step 9. Thus, by using container orchestration platform 101 to store data 302, virtual machine 103 does not need to perform any encryption or decryption of data 302 itself.

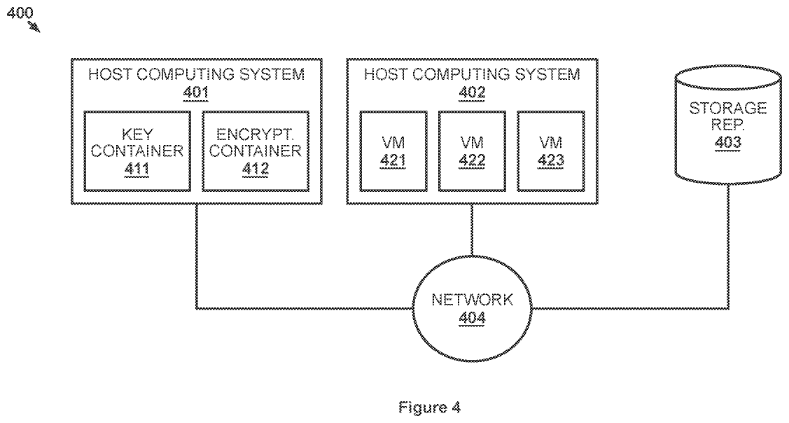

FIG. 4 illustrates implementation 400 for encrypting data at rest for virtual machines in a cloud environment. Implementation 400 includes host computing system 401, host computing system 402, storage repository 403, and communication network 404. Host computing system 401 and host computing system 402 are physical computing systems that may include processing circuitry (e.g., one or more processors), communication circuitry (e.g., one or more network interface cards), computer readable storage media, or some other type of computing hardware—including combinations thereof. Storage repository 403 includes computer readable storage media and communications circuitry. Communication network 404 may include one or more wired and/or wireless communication links, routers, switches, firewalls, or some other type of data communications device—including combinations thereof. Host computing system 401, host computing system 402, and storage repository 403 communicate over communication network 404. Host computing system 401 hosts key service container 411 and encryption service container 412 while host computing system 402 hosts virtual machines 421-423.

In this example, host computing system 401, host computing system 402, and storage repository 403 are provided by a cloud computing provider to an entity (e.g., a business that is a customer of the provider) to execute at least containers 411-412 and virtual machines 421-423 thereon. Additional host computing systems and/or storage repositories may be available to the entity or may be available for other entities to use. Communication network 404 may be connected to remote computing systems of the entity (e.g., over the Internet) to exchange information regarding the execution of containers 411-412 and virtual machines 421-423. Similarly, communication network 404 may enable host computing systems 401-402 to connect to systems other than those of the entity or cloud computing provider (e.g., virtual machines 421-423 may be web servers that provide a website to requesting systems). While not shown, software (e.g., a container engine and a hypervisor) is executing on host computing systems 401-402 to host containers 411-412 and virtual machines 421-423.

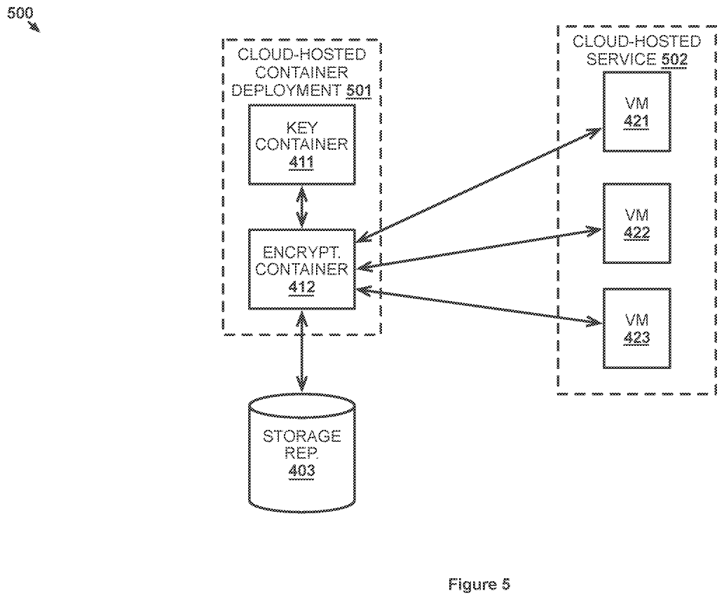

FIG. 5 illustrates logical arrangement 500 of the above implementation when encrypting data at rest for virtual machines in a cloud environment. Logical arrangement 500 illustrates logical communication links between containers 411-412, virtual machines 421-423, and storage repository 403 that are enabled by host computing systems 401-402, storage repository 403, and communication network 404. The logical communication links may be part of a logical network or may be direct links. Although not shown, additional logical links may exist, such as logical links connecting virtual machines 421-423. As shown in logical arrangement 500, containers 411-412 are part of cloud-hosted container deployment 501 which is instantiated by a container orchestration platform to perform data encryption services on behalf of virtual machines 421-423. Encryption service container 412 containerizes a process that services requests for encrypting/decrypting data. Similarly, key service container 411 containerizes a process that services request for newly generated encryption keys. A separate container may be executing on host computing system 401 or some other host computing system of the cloud computing provider to implement a control plane for the cloud computing platform. Virtual machines 421-423 are part of cloud-hosted service 502. As such, the above-mentioned entity executes virtual machines 421-423 on computing systems provided by the cloud computing provider to implement cloud-hosted service 502 and further executes containers 411-412 as cloud-hosted container deployment 501 to handle encryption for virtual machines 421-423 without having to rely on the cloud computing provider for the encryption.

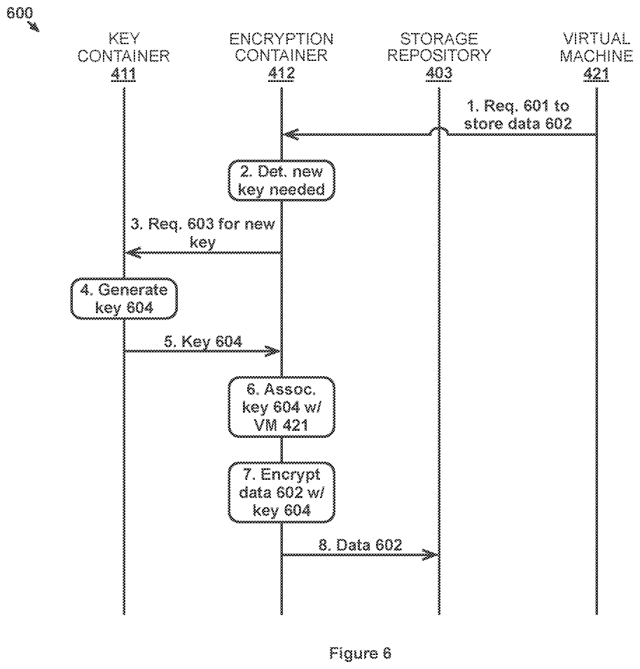

FIG. 6 illustrates operational scenario 600 for encrypting data at rest for virtual machines in a cloud environment. In operational scenario 600, virtual machine 421 transmits data access request 601 at step 1 to encryption service container 412. Data access request 601 requests that data 602 be stored in storage repository 403 and provides an identifier for virtual machine 421. Data 602 is included with data access request 601 in this example. Virtual machine 421, or a process executing on virtual machine 421, is configured to use encryption service container 412 for storing data. In some examples, encryption service container 412 may present itself to virtual machine 421 as being a storage repository (i.e., virtual machine 421 may interact with encryption service container 412 using the same commands as it would storage repository 102).

Upon receiving data access request 601, encryption service container 412 determines that a new key is needed from key service container 411 to encrypt data 602. Encryption service container 412 may maintain a data structure that associates keys and virtual machine identifiers. A new key may be needed when no key is associated with the identifier of virtual machine 421 in the data structure (e.g., data access request 601 may be the first request from virtual machine 421). Alternatively, a key that is associated with the identifier of virtual machine 421 in the data structure may have expired. For example, encryption service container 412 may be configured to no use any key older than one week. The age of the keys may be stored in the data structure that associates the keys and virtual machine identifiers or may be tracked elsewhere. Should encryption service container 412 find a key associated with the identifier of virtual machine 421 but determine that the key is older than one week, encryption service container 412 determines that a new key is necessary. Even when it is determined that a new key is needed, encryption service container 412 maintains the old key(s) associated with virtual machine 421 until all data encrypted using those keys is either removed from storage repository 403 or re-encrypted using an unexpired key. Data stored on behalf of virtual machine 421 using those previous keys can still be decrypted upon request from virtual machine 421.

In response to determining that a new key is needed, encryption service container 412 transmits key request 603 at step 3 to key service container 411. Key service container 411 generates new keys at the request of encryption service container 412. Key request 603 may be transmitted in any messaging format understood by containers 411-412. Upon receiving key request 603, key service container 411 generates key 604 at step 4. Key 604 comprises data that complies with what is needed by the encryption algorithm used by encryption service container 412. Key 604 may be a randomly generated string of data, may be generated using a data generation algorithm, may be generated using a YAML template, or may be generating using some other mechanism. Key 604 is transmitted at step 5 to encryption service container 412 in response to key request 603.

At step 6, encryption service container 412 associates key 604 with the identifier of virtual machine 421 in the data structure that maintains the association of keys and virtual machines. As noted above, the data structure may also include other keys associated with the identifier of virtual machine 421 and those keys may remain until no longer needed to decrypt data stored in storage repository 403. Associating key 604 with the identifier of virtual machine 421 also enables encryption service container 412 to identify key 604 later on when virtual machine 421 requests data 602. Encryption service container 412 inputs data 602 and key 604 into an encryption algorithm to encrypt data 602 at step 7 based on key 604. Once data 602 is encrypted, encryption service container 412 transmits data 602 at step 8 to storage repository 403 for storage thereat.

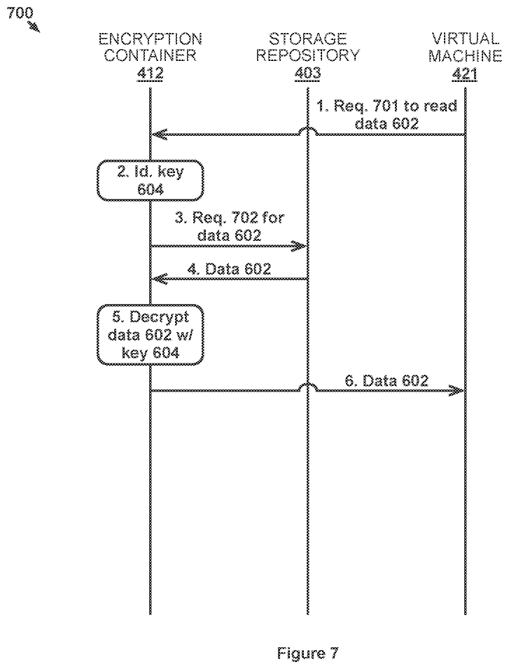

FIG. 7 illustrates operational scenario 700 for encrypting data at rest for virtual machines in a cloud environment. Operational scenario 700 is an example of how virtual machine 421 retrieves the encrypted data 602 from storage repository 403 via encryption service container 412. Virtual machine 421 transmits data access request 701 at step 1 to encryption service container 412. Data access request 701 requests that data 602 be read, decrypted, and provided to virtual machine 421. Data access request 701 includes the identifier of virtual machine 421. In response to receiving data access request 701, encryption service container 412 references the data structure storing the associations between keys and virtual machine identifiers. Key 604 is at least one of the keys associated with virtual machine 421 via its identifier in the data structure. In examples where keys expire, other keys that were used to encrypt data from virtual machine 421 that remains stored in storage repository 403 may also be associated with the identifier of virtual machine 421. In those examples, the data structure may further indicate that key 604 was used to encrypt data 602 rather than one of the other keys associated with virtual machine 421.

Encryption service container 412 transmits data read request 702 at step 3 to request data 602 from storage repository 403. Storage repository 403 transmits data 602 to encryption service container 412 at step 4 in response to data read request 702. Encryption service container 412 decrypts data 602 using key 604 at step 5. Encryption service container 412 the returns decrypted data 602 to virtual machine 421 at step 6 in response to data access request 701. Had a system other than virtual machine 421 (virtual machine or otherwise) requested data 602, the proper key for decrypting data 602 (i.e., key 604) would not have been associated with that system. Encryption service container 412 would have, therefore, not been able to decrypt data 602. In such an example, encryption service container 412 may not even request data 602 from storage repository 403 because encryption service container 412 will be unable to decrypt data 602 anyway.

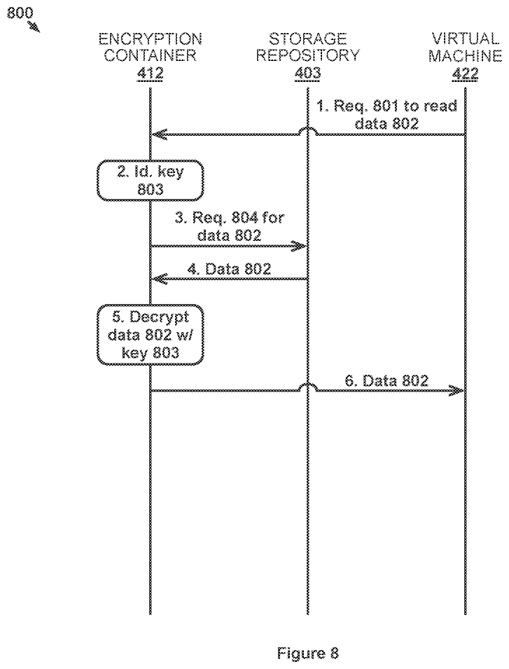

FIG. 8 illustrates operational scenario 800 for encrypting data at rest for virtual machines in a cloud environment. As mentioned above, encryption service container 412 can handle data encryption on behalf of multiple virtual machines. Operational scenario 800 is an example where another of virtual machines 421-423 uses encryption service container 412 for data encryption. Operational scenario 800 is, therefore, very similar to operational scenario 700 discussed above with virtual machine 422 replacing virtual machine 421. In particular, encryption service container 412 receives data access request 801 at step 1 from virtual machine 422. Data access request 801 requests that data 802 be read from storage repository 403, decrypted, and provided to virtual machine 422. Data access request 801 further includes the identifier of virtual machine 422. In this example, data 802 is data that was previously stored by encryption service container 412 on behalf of virtual machine 422 in a manner similar to that described in operational scenario 600.

Upon receiving data access request 801, encryption service container 412 determines at step 2 that key 803 is associated with the identifier of virtual machine 422 and was used to encrypt data 802. Encryption service container 412 uses the same data structure of key and virtual machine identifier associations as was used above to find key 803 being associated with virtual machine 422. Encryption service container 412 transmits data read request 804 to request data 802 at step 3 from storage repository 403. Storage repository 403 provides data 802 at step 4 in response to data read request 804. Upon receiving data 802, encryption service container 412 decrypts data 802 at step 5 using key 803. Decrypted data 802 is then provided to virtual machine 422 at step 6 in response to data access request 801.

As made clear in the above example, encryption service container 412 handles data encryption for data stored in storage repository 403 on behalf of at least virtual machine 421 and virtual machine 422. In some examples, encryption service container 412 may reach a limit as to the number of data access requests it can handle. That is, the processing resources of host computing system 401 being used by encryption service container 412 may not be able to support more data access requests from more virtual machines. In such situations, the container orchestration platform may instantiate one or more other cloud-hosted container deployments to complement cloud-hosted container deployment 501. Encryption service containers in the new deployments can the provide the additional encryption capacity to addition virtual machines and potentially take over the encryption services for one or more virtual machines being serviced by encryption service container 412. If a virtual machine is transferred from encryption service container 412 to another encryption service container, then the keys associated with that virtual machine are also transferred so that data can still be retrieved and decrypted on behalf of the transferred virtual machine.

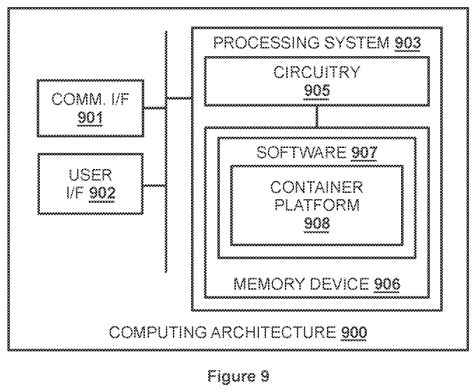

FIG. 9 illustrates computing architecture 900 for encrypting data at rest for virtual machines in a cloud environment. Computing architecture 900 is an example computing architecture for host computing systems described herein, such as systems 401 and 402, although systems 401 and 402 may use alternative configurations. Computing architecture 900 comprises communication interface 901, user interface 902, and processing system 903. Processing system 903 is linked to communication interface 901 and user interface 902. Processing system 903 includes processing circuitry 905 and memory device 906 that stores operating software 907.

Communication interface 901 comprises components that communicate over communication links, such as network cards, ports, RF transceivers, processing circuitry and software, or some other communication devices. Communication interface 901 may be configured to communicate over metallic, wireless, or optical links. Communication interface 901 may be configured to use TDM, IP, Ethernet, optical networking, wireless protocols, communication signaling, or some other communication format—including combinations thereof.

User interface 902 comprises components that interact with a user. User interface 902 may include a keyboard, display screen, mouse, touch pad, or some other user input/output apparatus. User interface 902 may be omitted in some examples.

Processing circuitry 905 comprises microprocessor and other circuitry that retrieves and executes operating software 907 from memory device 906. Memory device 906 comprises one or more computer readable storage media, such as a disk drive, flash drive, data storage circuitry, or some other memory apparatus. In no examples would a computer readable storage medium of memory device 906, or any other computer readable storage medium herein, be considered a transitory form of signal transmission (often referred to as “signals per se”), such as a propagating electrical or electromagnetic signal or carrier wave. Operating software 907 comprises computer programs, firmware, or some other form of machine-readable processing instructions. Operating software 907 includes container platform 908. Operating software 907 may further include an operating system, utilities, drivers, network interfaces, applications, or some other type of software. When executed by processing circuitry 905, operating software 907 directs computing architecture 900 to operate as described herein.

In particular, container platform 908 directs computing architecture 900 to receive a data access request from a virtual machine external to the container orchestration platform. The data access request requests that data be stored in a storage repository. After receiving the data access request, container platform 908 directs computing architecture 900 to encrypt the data using a key associated with the virtual machine and, after encrypting the data, store the data in the storage repository.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method comprising:
in a container orchestration platform:
receiving a data access request from a virtual machine external to the container orchestration platform, wherein the data access request requests that data be stored in a storage repository;
after receiving the data access request, encrypting the data using a key associated with the virtual machine; and
after encrypting the data, storing the data in the storage repository.

2. The method of claim 1, comprising:
in response to determining that a new key should be used for encrypting the data, creating the key.

3. The method of claim 2, wherein creating the key comprises using a YAML template for key generation.

4. The method of claim 2, comprising:
determining that the new key should be used when a previous key has expired.

5. The method of claim 2, wherein:
a containerized encryption service receives the data access request and encrypts the data; and
a containerized key service creates the key.

6. The method of claim 5, wherein the containerized key service provides the key to the containerized encryption service in response to a request for the key from the containerized encryption service.

7. The method of claim 1, comprising:
in the container orchestration platform:
receiving another data access request from the virtual machine, wherein the other data access request requests the data from the storage repository;
decrypting the data using the key; and
after decrypting the data, providing the data to the virtual machine.

8. The method of claim 1, comprising:
in the container orchestration platform:
receiving a second data access request from a second virtual machine, wherein the second data access request requests that second data be stored in the storage repository;
in response to the second data access request, encrypting the data using a second key associated with the second virtual machine; and
after encrypting the second data, storing the second data in the storage repository.

9. The method of claim 1, comprising:
identifying the key from a data structure that stores associations between keys and virtual machines.

10. The method of claim 1, wherein the key is only used for data access requests received from the virtual machine.

11. An apparatus comprising:
one or more computer readable storage media;
a processing system operatively coupled with the one or more computer readable storage media; and
program instructions stored on the one or more computer readable storage media that, when read and executed by the processing system, direct the apparatus to:
in a container orchestration platform:
receive a data access request from a virtual machine external to the container orchestration platform, wherein the data access request requests that data be stored in a storage repository;
after receiving the data access request, encrypt the data using a key associated with the virtual machine; and
after encrypting the data, store the data in the storage repository.

12. The apparatus of claim 11, wherein the program instructions direct the apparatus to:
in response to determining that a new key should be used for encrypting the data, create the key.

13. The apparatus of claim 12, wherein to create the key, the program instructions direct the apparatus to use a YAML template for key generation.

14. The apparatus of claim 12, wherein the program instructions direct the apparatus to:
determine that the new key should be used when a previous key has expired.

15. The apparatus of claim 12, wherein:
a containerized encryption service receives the data access request and encrypts the data; and
a containerized key service creates the key.

16. The apparatus of claim 15, wherein the containerized key service provides the key to the containerized encryption service in response to a request for the key from the containerized encryption service.

17. The apparatus of claim 11, wherein the program instructions direct the apparatus to:
in the container orchestration platform:
receive another data access request from the virtual machine, wherein the other data access request requests the data from the storage repository;
decrypt the data using the key; and
after decrypting the data, provide the data to the virtual machine.

18. The apparatus of claim 11, wherein the program instructions direct the apparatus to:
in the container orchestration platform:
receive a second data access request from a second virtual machine, wherein the second data access request requests that second data be stored in the storage repository;
in response to the second data access request, encrypt the data using a second key associated with the second virtual machine; and
after encrypting the second data, store the second data in the storage repository.

19. The apparatus of claim 11, wherein the program instructions direct the apparatus to:
identify the key from a data structure that stores associations between keys and virtual machines.

20. One or more computer readable storage media having program instructions stored thereon that, when read and executed by a processing system, direct the processing system to:
in a container orchestration platform:
receive a data access request from a virtual machine external to the container orchestration platform, wherein the data access request requests that data be stored in a storage repository;
after receiving the data access request, encrypt the data using a key associated with the virtual machine; and
after encrypting the data, store the data in the storage repository.
